(19) United States
(12) Patent Application Publication
(10) Pub. No.: US 2022/0104504 A1
(43) Pub. Date: Apr. 7, 2022

(54) HIGH PROTEIN FROZEN FOOD PRODUCT AND METHOD

(71) Applicant: Kellogg Company, Battle Creek, MI (US)

(72) Inventors: Allen McGee, Minneapolis, MN (US); Pedro Alvarez, Portage, MI (US)

(21) Appl. No.: 17/421,135

(22) PCT Filed: Jan. 2, 2020
(86) PCT No.: PCT/US2020/012029

§ 371 Date: Jul. 7, 2021

Related U.S. Application Data
(60) Provisional application No. 62/789,822, filed on Jan. 8, 2019.

(51) Int. Cl. A21D 2/26; A21D 2/36; A21D 8/06; A21D 15/02; A21D 13/064

(52) U.S. Cl. CPC A21D 2/263; A21D 2/36; A21D 13/064; A21D 15/02; A21D 8/06

(57) ABSTRACT

A method of producing a food product (10) includes preparing a first mixture by combining protein, water, egg, oil, and lecithin. The method further includes mixing the first mixture for a first period of time. A second mixture is prepared by combining the first mixture, water, wheat flour, sweetener, protein isolate, a leavening agent, and salt. The second mixture is mixed for a second period of time, and then baked to form the food product.

### CROSS REFERENCE TO RELATED APPLICATIONS

This application claims priority under 35 U.S.C. § 119(e) to U.S. Provisional Application 62/789,822, filed on Jan. 8, 2019. The disclosure of this prior application is considered part of the disclosure of this application and is hereby incorporated by reference in its entirety.

### TECHNICAL FIELD

This disclosure relates to a baked and frozen food product, and particularly to a frozen waffle having a high protein content.

### BACKGROUND

Food products and food product manufacturing systems are known. While existing food products and food product manufacturing systems and methods perform adequately for their intended purpose, improvements to food products and food product manufacturing systems and methods are continuously being sought in order to advance the arts.

### SUMMARY

This section provides a general summary of the disclosure, and is not a comprehensive disclosure of its full scope or all of its features.

The details of one or more implementations of the disclosure are set forth in the accompanying drawings and the description below. Other aspects, features, and advantages will be apparent from the description and drawings, and from the claims.

### DESCRIPTION OF DRAWINGS

The drawings described herein are for illustrative purposes only of selected configurations and not all possible implementations, and are not intended to limit the scope of the present disclosure.

FIG. 1 is a perspective view of a food product according to the principles of the present disclosure;

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

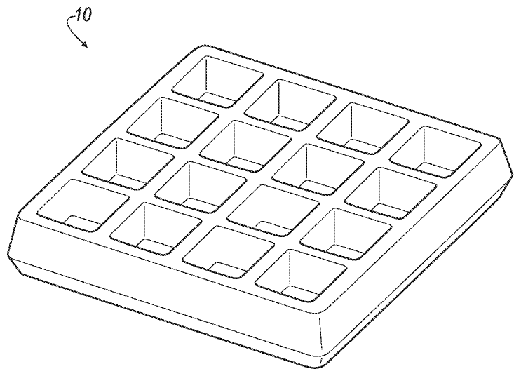

With reference to FIG. 1, the present disclosure relates to a baked and frozen, high-protein food product 10, and more particularly, to a frozen waffle 10 having a total protein content of at least 18 g per 100 g (i.e., 18 percent by weight). Generally, the food product 10 is a batter-based food product, whereby a semiliquid mixture of ingredients is cooked to form the food product 10. Optionally, the cooked food product 10 may then be frozen and stored. Unlike batters used in conventional batter-based food products, the batter of the present disclosure is prepared in a multi-stage process, whereby a first mixture is prepared in a first stage using a first combination of ingredients, and then a second mixture is prepared in a second stage using a second combination of ingredients including the first mixture.

In a first step, the first mixture is prepared by combining a first group of ingredients including water, a fat, a protein source, egg, an emulsifier, and one or more flavorings. Examples of formulations for the first mixture is shown in Table 1, below.

TABLE 1
First Mixture (Generic)

| | % Weight | % Weight |
|---|---|---|
| Ingredient | Example 1 | Example 2 |
| Water | 45-65% | 52-56% |
| Canola Oil | 15-30% | 22-24% |
| Whey Protein Concentrate | 5-20% | 13-14% |
| Dried Whole Egg | 0-6% | 2.5-3% |
| Dried Egg Whites | 0-6% | 2.5-3% |
| Lecithin | 0.5-3% | 0.5-2% |
| Liquid Sweetener | 0-5% | 0-2% |

In the example of the first mixture provided in Table 1, the protein source comprises whey protein. However, the protein source can be chosen from, but not limited to, egg albumen, whey protein, soy protein, vital wheat gluten, peanut protein, pea protein, or mixtures thereof.

Referring again to Table 1, in the illustrated example, the fat comprises canola oil. However, in other examples the fat may be chosen from, but not limited to, non-hydrogenated vegetable oil, non-hydrogenated shortening, partially hydrogenated vegetable oil, partially hydrogenated shortening, fully hydrogenated vegetable oil, fully hydrogenated shortening, soybean oil, cottonseed oil, peanut oil, safflower oil, sunflower oil, coconut oil, palm oil, palm kernel oil, olive oil, butterfat oil, cocoa butter oil, tallow, lard, corn oil, or mixtures thereof.

The egg of the of the first mixture is chosen from, but is not limited to, liquid whole egg, dry whole egg, liquid egg whites, dry egg whites or mixtures thereof.

The emulsifier of the illustrated example is a lecithin. However, other emulsifiers that may be used include, but are not limited to, glycerol esters, diacetyl tartaric acids, esters of monoglycerides, mono and di-glycerides, polyglycerol esters, polysorbate, propylene glycol esters, rice extract esters, sodium stearoyl-2-lactylate, sorbitan esters, lecithins, sugar esters, acetylated monoglycerides, or mixtures thereof.

Optionally, a liquid sweetener, such as sugar molasses may also be included in the first mixture.

The first group of ingredients is then mixed for a first mixing period to form the first mixture. The first group of ingredients may be mixed using conventional mixing methods and systems. Mixing the first group of ingredients for the first mixing period allows for the protein source to be hydrated and coated prior to introducing the ingredients of the second mixture, as discussed below. Particularly, the oil added in the first stage coats the protein molecules to control the amount of water absorbed by the proteins. Thus, the water added in the first stage is absorbed by the proteins prior to coating, and then the water added in the second stage remains free for use by the ingredients of the second stage and results in a less powdery, more chewable final product. A first mixing period of at least 45 seconds, preferably ranging from 45 seconds to 65 seconds, and more preferably of 55 seconds, has been found to be a suitable duration for allowing the protein to be hydrated and fat coated.

Once the first mixture is prepared and mixed such that the proteins are sufficiently hydrated and coated by the fats, the first mixture is combined and mixed with a second group of ingredients to form a second mixture. The group of ingredients for the second stage includes the first mixture, water, flour, sweetener, isolated protein, flavoring, a leavening agent, a chelating agent, salt, and a leavening acid. In some examples, hemp seeds may also be included in the second mixture. Examples of formulations for the second mixture is shown in Table 2, below.

TABLE 2
Second Mixture (Generic)

| | Example 1 | Example 2 |
|---|---|---|
| Ingredient | % Weight | % Weight |
| First Mixture | 35-55% | 38-41% |
| Water | 15-25% | 19-23% |
| Soft Red Wheat (SRW) (Graham Flour) | 15-25% | 22-25% |
| Sweetener | 0-8% | 1-7% |
| Isolated Soy Protein | 5-10% | 6-8% |
| Hulled Hemp Seeds | 1-5% | 2-3% |
| Leavening Agent | 0-2% | 0.75-1.25% |
| Sea Salt Purified | 0-1% | 0.05-0.15% |

In the illustrated example, the flour of the second mixture comprises a wheat flour. However, in other examples, the flour may include all-purpose flour, hard wheat flour, soft wheat flour, whole wheat flour, corn flour, oat flour, rice flour, barley flour, or mixtures thereof.

The leavening agent of the second mixture may include at least one of fumaric acid, adipic acid, aceteic acid, tartaric acid, monocalcium phosphate monohydrate, anhydrous monocalcium phosphate, anhydrous dicalcium phosphate, dicalcium phosphate dihydrate, sodium acid pyrophosphate, sodium acid pyrophosphate, sodium aluminum phosphate, monoaluminum phosphate, dialuminum phosphate, monoammonium phosphate, diammonium phosphate, sodium aluminum sulfate, sodium bicarbonate or mixtures thereof. In some examples, the leavening agent may be baking soda.

The salt preferably is chosen from, but is not limited to, sodium chloride, potassium chloride, calcium chloride, or mixtures thereof.

The sweetener preferably is chosen from, but is not limited to, sucrose, dextrose, fructose, lactose, malt syrup, malt syrup solids, rice syrup solids, rice syrup, invert sugar, malt syrup, malt syrup solids, refiners syrup, corn syrup, corn syrup solids, maltose, high fructose Corn syrup, honey, molasses, glycerrhizin, arabinose, galactose, glucose, mannitol, maple syrup, ribose, saccharin, xylose, artificial sweeteners, or mixtures thereof. Examples of sweeteners include brownulated sugar, evaporated cane syrup crystals.

The second group of ingredients are mixed for a second mixing period using conventional mixing methods and systems. A second mixing period of at least 90 seconds, preferably from 90 seconds to 150 seconds, and more preferably of 120 seconds, has been found to be a suitable. Here, the second mixture is a semiliquid batter that is used in producing the food product.

Once the second mixture is mixed to form a homogenous batter, the batter is provided to a cooking apparatus, such as an oven or fryer. In some examples, one or more flavorings or additives may be added to the cooking apparatus contemporaneously with the batter. For example, flavoring pieces such as chocolate or cinnamon, or fruit, may be added to the batter prior to cooking. In one example, the batter is baked in a waffle iron to form one or more waffles 10. The waffles 10 may then be packaged and frozen for storage, shipment, and sale.

### Example 1

In one example, a vanilla buttermilk flavored batter is prepared. Here, the ingredients of the first mixture (shown in Table 3) are added to the mixture and blended for a period of 60 seconds.

TABLE 3
First Mixture (Vanilla Buttermilk)

| Ingredient | % Weight |
|---|---|
| Water | 52.28% |
| Canola Oil | 23.10% |
| Whey Protein Concentrate | 13.59% |
| Dried Whole Egg | 2.70% |
| Dried Egg Whites | 2.70% |
| Lecithin | 1.16% |
| Vanilla | 3.81% |
| Brown Sugar Molasses | 0.65% |

Once the ingredients of the first mixture are sufficiently blended such that the proteins are hydrated and coated, the remaining ingredients of the second mixture are mixed with the first mixture, as shown in Table 4, below. Here, the ingredients of the second mixture are blended for about 120 seconds to form a substantially homogenous batter.

TABLE 4
Second Mixture (Vanilla Buttermilk)

| Ingredient | % Weight |
|---|---|
| First Mixture | 39.33% |
| Water | 20.56% |
| Soft Red Wheat (SRW) Graham Flour) | 22.72% |
| Evaporated Cane Syrup Crystals | 6.82% |
| Isolated Soy Protein | 6.68% |
| Hulled Hemp Seeds | 2.27% |
| Butermilk Blend | 0.54% |
| Sodium Bicarbonate | 0.52% |
| Sodium Acid Pyrophosphate | 0.38% |
| Sea Salt Purified | 0.11% |
| Monocalcium Phosphate | 0.07% |

The batter is then provided to a cooking apparatus to form a baked waffle or other food product. Once baked, the waffle can be frozen and packaged.

### Example 2

in one example, a brown sugar and cinnamon flavored batter is prepared. Here, the ingredients of the first mixture (shown in Table 5) are added to the mixture and blended for a period of 60 seconds.

TABLE 5
First Mixture (Brown Sugar Cinnamon)

| Ingredient | % Weight |
|---|---|
| Water | 55.14% |
| Canola Oil | 23.57% |
| Whey Protein Concentrate | 13.21% |
| Dried Whole Egg | 2.77% |
| Dried Egg Whites | 2.77% |
| Lecithin | 1.18% |
| Brown Sugar Molasses | 1.35% |

Once the ingredients of the first mixture are sufficiently blended such that the proteins are hydrated and coated, the remaining ingredients of the second mixture are mixed with the first mixture, as shown in Table 6, below. Here, the ingredients of the second mixture are blended for about 120 seconds to form a substantially homogenous batter.

TABLE 6
Second Mixture (Brown Sugar Cinnamon)

| Ingredient | % Weight |
|---|---|
| First Mixture | 40.33% |
| Water | 22.24% |
| Soft Red Wheat (SRW) Graham Flour) | 24.18% |
| Isolated Soy Protein | 7.55% |
| Hulled Hemp Seeds | 2.67% |
| Brownulated Sugar | 1.90% |
| Sodium Bicarbonate | 0.55% |
| Sodium Acid Pyrophosphate | 0.39% |
| Sea Salt Purified | 0.12% |
| Monocalcium Phosphate | 0.08% |

in this example, the batter formed by the second mixture is added to the cooking apparatus contemporaneously with sugar cinnamon pieces, where the sugar cinnamon pieces are added at a rate of 4.85 percent by weight of the second mixture deposit rate.

### Example 3

In one example, a wild blueberry flavored batter is prepared. Here, the ingredients of the first mixture (shown in Table 7) are added to the mixture and blended for a period of 60 seconds.

TABLE 7
First Mixture (Wild Blueberry)

| Ingredient | % Weight |
|---|---|
| Water | 53.86% |
| Canola Oil | 23.52% |
| Whey Protein Concentrate | 13.44% |
| Dried Whole Egg | 2.77% |
| Dried Egg Whites | 2.77% |
| Lecithin | 1.77% |
| Blueberry Flavoring | 1.29% |
| Granulated Lemon Peel | 0.59% |

Once the ingredients of the first mixture are sufficiently blended such that the proteins are hydrated and coated, the remaining ingredients of the second mixture are mixed with the first mixture, as shown in Table 8, below. Here, the ingredients of the second mixture are blended for about 120 seconds to form a substantially homogenous batter.

TABLE 8
Second Mixture (Wild Blueberry)

| Ingredient | % Weight |
|---|---|
| First Mixture | 39.64% |
| Water | 21.37% |
| Soft Red Wheat (SRW) Graham Flour) | 22.66% |
| Isolated Soy Protein | 7.55% |
| Evaporated Cane Syrup Crystals | 5.33% |
| Hulled Hemp Seeds | 2.33% |
| Sodium Bicarbonate | 0.54% |
| Sodium Acid Pyrophosphate | 0.38% |
| Sea Salt Purified | 0.12% |
| Monocalcium Phosphate | 0.07% |

In this example, the batter formed by the second mixture is added to the cooking apparatus contemporaneously with frozen blueberries, where the blueberries are added at a rate of 5.3 percent by weight of the second mixture deposit rate.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of producing a food product (10), the method comprising;
preparing a first mixture by combining protein, water, egg, oil, and lecithin;
mixing the first mixture for a first period of time;
preparing a second mixture by combining the first mixture, water, wheat flour, sweetener, protein isolate, a leavening agent, and salt;
mixing the second mixture for a second period of time;
baking the second mixture to form the food product (10).

2. The method of claim 1, further comprising freezing the food product (10).

3. The method of claim 1, wherein preparing the second mixture further includes adding hemp seeds.

4. The method of claim 1, wherein the first period of time ranges from 45 seconds to 75 seconds.

5. The method of claim 1, wherein the second period of time ranges from 90 seconds to 150 seconds.

6. The method of claim 1, wherein the baking step ranges from 45 seconds to 65 seconds.

7. The method of claim 1, wherein the protein is whey protein.

8. The method of claim 1, wherein the preparing the first mixture includes combining protein in an amount ranging from 5% to 20% by weight of the first mixture, water in an amount ranging from 45% to 65% by weight of the first mixture, oil in an amount ranging from 15% to 30% by weight of the first mixture, and lecithin in an amount ranging from 1% to 3% by weight of the first mixture.

9. The method of claim 1, wherein the preparing the second mixture includes combining the first mixture in an amount ranging from 35% to 55% by weight of the second mixture, water in an amount ranging from 15% to 25% by weight of the second mixture, wheat flour in an amount ranging from 15% to 25% by weight of the second mixture, sweetener in an amount ranging from 0% to 8% by weight of the second mixture, protein isolate in an amount ranging from 5% to 10% by weight of the second mixture, hemp seeds in an amount ranging from 1% to 5% by weight of the second mixture, leavening agent in an amount ranging from 0% to 1% by weight of the second mixture, and salt in an amount ranging from 0% to 1% by weight of the second mixture.

10. The method of claim 1, wherein the baking step is done in a waffle iron.

11. The method of claim 1, whereby the food product (10) has a total protein content of at least 18 percent by weight.

12. The method of claim 1, further comprising contemporaneously providing the second mixture and an additive to a cooking device.

13. The method of claim 12, wherein the additive includes food pieces.

14. A food product (10) prepared by a method comprising the steps of:
preparing a first mixture by combining protein, water, egg, oil, and lecithin;
mixing the first mixture for a first period of time;
preparing a second mixture by combining the first mixture, water, wheat flour, sweetener, protein isolate, a leavening agent, and salt;
mixing the second mixture for a second period of time;
baking the second mixture to form the food product (10).
